(19) United States
(12) Patent Application Publication
(10) Pub. No.: US 2010/0136304 A1
(43) Pub. Date: Jun. 3, 2010

(54) SAFETY LABEL

(76) Inventor: Werner Hagmaier, Muensingen (DE)

Correspondence Address: KRIEGSMAN & KRIEGSMAN, 30 TURNPIKE ROAD, SUITE 9, SOUTHBOROUGH, MA, 01772, US

(21) Appl. No.: 12/452,597

(22) PCT Filed: Jul. 8, 2008
(86) PCT No.: PCT/EP2008/005532

§ 371 Date: Jan. 11, 2010

(30) Foreign Application Priority Data
Jul. 11, 2007 (DE) 10 2007 032 619.1

(51) Int. Cl. B32B 5/16; B05D 5/12; B05D 3/06

(52) U.S. Cl. 428/204; 427/131; 427/516

(57) ABSTRACT

The invention relates to a safety label allowing magnetic influences exerted thereon to be visualised by means of magnetic metal particles arranged within a multi-layer construction (12) and to a method of fabricating said safety label, a gel-like function layer (18) containing magnetically responsive metal particles incorporated therein being applied to the support layer (14), at least in specific zones, and surrounded by an adhesive layer (19) arranged on the support layer (14), the gel-like function layer (18) being covered by a covering layer (24) which is provided on a protective layer (28), such that the magnetically responsive metal particles may migrate from the function layer (18) to the covering layer (24) when exposed to a magnetic influence and the proportion of metal particles having passed into the covering layer (24) is visualable.

The invention relates to a safety label according to the preamble of claim 1.

WO 03/061960 A1 discloses a label allowing magnetic influences or magnetic forces to be visualised. This label comprises a multi-layer construction having a first substrate layer which is applied to a layer of magnetically sensitive microcapsules. The last-mentioned layer is provided with an opaque background layer which may be fixed to an object by means of an adhesive layer. The magnetically sensitive microcapsules comprise a mixture of magnetic particles in a suspending vehicle. Such magnetic particles are made of metal and are provided with first and second surfaces having different optical surfaces. When a magnetic field acts on this layer, the magnetic particles are oriented by rotation.

U.S. Pat. No. 5,079,058 discloses a laminated multi-layer construction in which a fluid layer which has on one side of the layer a powdery, magnetic material for forming a fluid film is prepared by a process that is enabled in response to the magnetic force. When the magnetic force exerts its influence, a pattern is to be produced by the magnetic elements in the fluid film which may consist, for example, of plastic and a solvent.

Such devices have the disadvantage of being costly in their fabrication. In addition, it is impossible to obtain an unambiguous visualisation of a magnetic force acting on the safety label. Moreover, these safety labels will not give any information on how long a magnetic force has acted on the security label.

The invention is therefore based on the object of creating a security label which has a simple structure and allows to gather information about the duration of action of a magnetic force on the safety label.

This object is achieved according to the invention by the characteristics of claim 1 and claim 13. Other advantageous configurations and developments are mentioned in the respective dependent claims.

By the configuration according to the invention of a safety label allowing magnetic influences exerted thereon to be visualised by means of a gel-like function layer applied to the support layer at least in specific zones and having metal particles incorporated therein, and by means of a covering layer which covers the function layer, wherein the magnetically responsive metal particles migrate from the function layer to the covering layer when exposed to a magnetic influence, an emigration process of the metal particles from the function layer and an immigration into the covering layer are enabled to take place, with the immigrated metal particles being visible in the covering layer as a magnetic force is exerted over a shorter or over a longer period of time. In addition, this configuration according to the invention makes it possible that a longer period of action of a magnetic force results in an increased incorporation of metal particles in the covering layer, such that owing to the increased inclusion of metal particles in the covering layer an optical change, for example a change in colour or opacification, is caused, the degree of the colour change or opacification being indicative of the duration of exposure to a magnetic field. Such information is advantageous in particular when the label is to be attached on electricity supply meters, not only to establish the fact that tampering has occurred but to indicate the time period during which such tampering has taken place. Tampering of this type permits to consume electricity without the electricity supply meter recording said consumption.

According to a preferred configuration of the invention, provision is made for the gel-like function layer to be solvent-free. This makes it possible to obtain a non-drying function layer, which ensures the longevity of the safety label. Owing to this non-drying function layer, the emigration function of the metal particles from the function layer is preserved.

According to another preferred configuration of the invention, provision is made for the gel-like function layer to be saturated with magnetically responsive metal particles. Thus, it is ensured that the magnetic particles are distributed in a uniform manner in the function layer and that an indication of magnetic influences is invariably possible and visualisable, even though a safety label of this type has been stored or attached to an object for a longer period of time.

It is preferred that the covering layer of the safety label is equally gel-like and preferably solvent-free. In case of influences caused by magnetic fields, the magnetic particles may thus pass through the covering layer in a uniform manner, resulting in a gradual, uniform change in colour or opacification of the covering layer, particularly in the region adjacent to the protective film. The longevity is ensured, by analogy with the function layer, due to the solvent-free configuration.

Furthermore, provision is preferably made for the covering layer, as considered in a planiform extension, to be larger than the gel-like function layer that is to be covered. This ensures that the metal particles contained within the function layer will not shimmer through and become visible on the surface, thus giving the impression of a tampering to have occurred. On the contrary, the covering layer preferably limits the display zone, the protective film being preferably transparent in the region of the covering layer.

Furthermore, provision is preferably made for the function layer to be provided with a photopolymerised layer formed by irradiation, in particular by UV irradiation. This photopolymerised layer or very thin skin makes it possible, on the one hand, that during the fabrication of the safety label the gel-like function layer will preserve the position and form in which it has been applied. On the other hand, this photopolymerised layer or skin present on the function layer is of decisive importance for the proportion of metal particles migrating from the function layer into the covering layer and thus determines the degree of change in colour or opacification of the covering layer, which depend on the duration of action of the magnetic field.

According to a further preferred configuration of the invention, provision is made for a photopolymerised layer or skin to be formable on the covering layer by irradiation, in particular by UV irradiation. The irradiation of the function layer and/or the covering layer may be carried out by means of a UV lamp, by laser irradiation, or the like. The remarks made above for the function layer also apply, by analogy, to this photopolymerised layer.

Furthermore, provision is preferably made for the transmigration speed of the magnetic metal particles into the covering layer to be determinable as a function of the viscosity of the gel-like function layer and/or of the thickness of the photopolymerised layer present on the function layer. By way of example, in case of a low viscosity, the transmigration speed is reduced. The same applies, by analogy, to the configuration of the photopolymerised layer with an increased thickness. This makes it possible to provide safety labels capable of detecting, for example, instances of tampering having lasted for more than 24 hours, for more than a week, or for more than a month, since, due to the viscosity of the gel-like function layer and/or the thickness of the photopolymerised layer, it takes such extended periods of time before the transmigration of the metal particles and their incorporation in the covering layer are accomplished, so that these metal particles incorporated in the covering layer are visible. By these parameters, it is possible to realise indicator zones on a safety label which respond to different durations of action, respectively, the individual indicator zones comprising the function layer, the covering layer, and the respective photopolymerised layers thereon, if present, being each provided with different parameters for their transmigration.

Furthermore, provision is preferably made for a transmigration speed of the magnetic metal particles into the covering layer to be determined as a function of the viscosity of the covering layer and/or of the thickness of the photopolymerised layer provided thereon. The same applies, by analogy, to the function layer. Depending on the gel-like materials used, photopolymerised layers of different thickness may be formed on the function layer and on the covering layer for achieving the adequate transmigration rates of the metal particles permitting to draw pertinent conclusions concerning the tamperings.

Preferably, the covering layer is provided with coloured pigments which are different from the metal particles. In this way, a change in colour or opacification, in particular a greying of the covering layer, may occur when white or light coloured pigments are used together with dark metal particles, the degree of colour change giving an indication of the time period during which a permanent magnetic field was applied. The increasing degree of greying of the covering layer is caused by the increasing number of metal particles, in particular ferrite powder particles, migrating into the covering layer, such that information concerning the duration of action of the magnetic field may be gathered from said degree of greying.

Provision is preferably made for the covering layer to be realised, at least in specific zones, as a transparent film. This permits to easily recognise tampering, if such tampering has occurred, while providing at the same time protection to the covering layer. For greater ease of fabrication, provision may be made for the support layer to receive both the function layer and the covering layer and to be transparent, so that a separate protective layer may be dispensed with.

The object on which the invention is based is further achieved by the characteristics of claim 13. The method according to the invention for fabricating the safety label allows an easy and cost-effective fabrication. Provision is made for the gel-like function layer which is applied to the support layer and for the covering layer associated with the function layer to be applied in a mirror-inverted manner along a straight line on the support layer, so that after the application of said layers it is possible to fold up the support layer along the straight line forming the mirror-symmetrical axis, by which folding-up the covering layer is associated with the function layer and covers the latter. This enables an easy and reliable handling of the gel-like function layer and covering layer, with the layers applied to specific zones being capable of preserving their shapes. The folding-up of the transport layer and the matching superposition of the at least one covering layer with the at least one function layer allow a cost-effective method to be realised, which makes it possible to fabricate the safety labels in a continuous manner in the form of a web material.

According to an advantageous development of the method, provision is made for the function layer to be photopolymerised using at least one irradiation source. This photopolymerisation preferably takes place prior to the folding-up of the support layer. Thus, the gel-like function layer may be sealed toward the upper side with a thin, preferably a very thin, skin or layer, said layer being designed to function as an additional time indicator for the action of the magnetic field.

According to another advantageous configuration of the method, provision is made for the function layer, the covering layer or the adhesive layer to be applied by a screen printing technique. This makes it possible for the individual layers to be applied in a simple and cost-effective manner, using known screen printing techniques.

Furthermore, provision is preferably made for the function layer to be saturated to a proportional extent of at least 40° A) with magnetically responsive metal particles. This enables a uniform distribution of the metal particles in the function layer, thus counteracting an uneven deposition after a longer period of utilisation without exposure to the influence of a magnetic field.

In addition, provision is preferably made for the covering layer to be saturated to a proportional extent of at least 40° A with coloured particles. At the same time, the coloured particles are selected with a colour differing from that of the metal particles. In this way a covering layer offering full coverage may be provided which takes a change in colour depending on the proportional degree of metal particle transmigration which, in turn, represents an indicator giving information on the duration of action of a magnetic field.

The invention, as well as other advantageous embodiments and developments thereof, will be described and explained in the following with reference being made to the examples shown in the drawings. The characteristics issuing from the description and the drawings may be applied according to the present invention either individually or as a plurality of features taken in any combination. In the drawings:

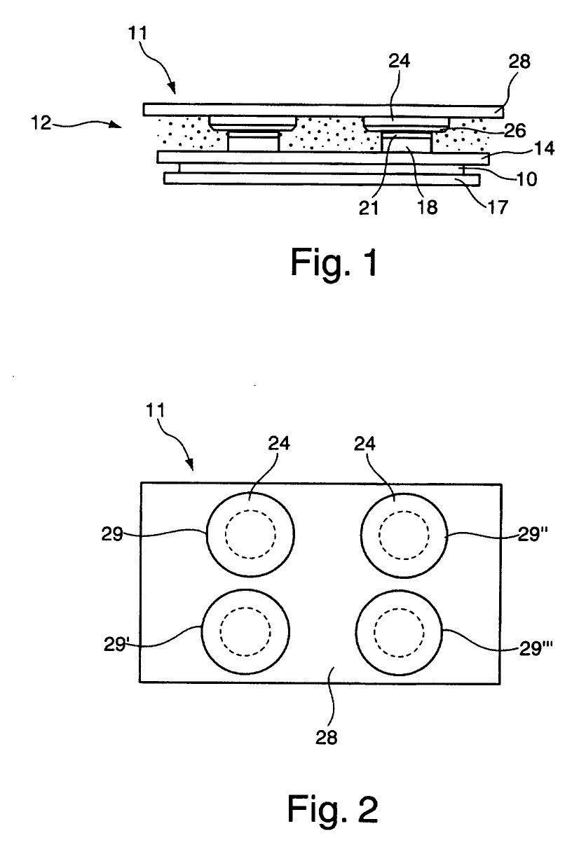

FIG. 1 is a schematic side view of the configuration according to the invention of a safety label;

FIG. 2 is a schematic top view of the safety label according to FIG. 1; and

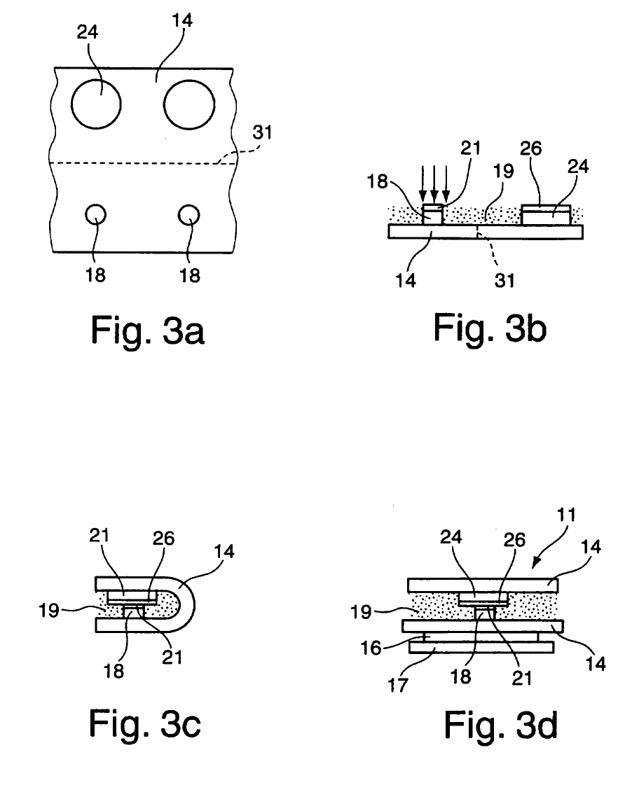

FIGS. 3a to c are schematically represented steps for fabricating a safety label according to FIG. 1.

FIG. 1 is a schematically enlarged sectional view of a safety label 11 allowing magnetic influences exerted thereon to be visualised. Safety labels 11 of this type preferably have a planiform extension ranging from some few square millimetres to several square centimetres. The safety label 11 comprises a multi-layer construction 12 having a support layer 14 which, according to the exemplary embodiment, is provided with a strongly adherent adhesive layer 16 and with a protective film 17 disposed thereon as a protection. An adhesive layer 16 and a protective film 17 of this type may be applied, if needed, both on the bottom surface and on the top surface of the safety label 11. A protective film 17 of this type is removed just before attaching the safety label 11 to its destination location, such that a self-adhesive safety label 11 is formed and is attachable to the destination location.

The support layer 14 receives a gel-like function layer 18 extending along the support layer 14, at least over specific zones. This gel-like function layer 18 is solvent-free. By way of example, the function layer 18 may be applied to the support layer 14 in a point-like or drop-like manner. By analogy, the function layer 18 may also be applied in a square or rectangular manner, as seen from an angle corresponding to a top view. Furthermore, patterns or graphic design elements may be provided on the function layer 18 which are preferably applied using a stencil.

Magnetically responsive metal particles are incorporated in the function layer 18, with a proportion of at least 60% of metal particles being provided, so that the gel-like function layer 18 is saturated. Between the function layers 18, an adhesive layer 19 is preferably provided which limits the function layer 18 in the extension direction of the support layer 14.

Depending on the size and the function of the safety label 11, one function layer 18 or a plurality of function layers 18 may be provided on the support layer 14 and may be arranged, for example, in series, in the form of a screen, or in other patterns. The application of a plurality of function layers 18 may be provided for the purpose of securing a larger zone against the action of magnetic fields. Moreover, the individual function layers 18 may differ from each other with respect to their configuration and their structure, in order to visualise different durations of action of magnetic fields. Furthermore, individual function layers may be realised in a structurally identical manner in order to provide redundancy, thus permitting to verify the correctness of the tampering detected in the redundant function layers 18.

On the surface opposite the support layer 14, the function layer 18 has a photopolymerised layer 21 which is realised in the form of a very thin layer or very thin skin. The function layer 18 and polymerised layer 21 are covered in their entirety by a covering layer 24. The covering layer 24 is preferably larger in its planiform extension, i.e. in the extension along the x-y-plane, than the function layer 18, thus ensuring a complete covering of the function layer 18. The covering layer 24 is preferably provided in the form of a solvent-free gel which may equally be formed with a photopolymerised layer 26. The covering layer 24 is saturated with a coloured pigment which is realised in a colour different from that of the metal particles. The covering layer 24 is supported by a protective film 28 which, at least in the zone of the covering layer 24, is realised as a transparent film. In a preferred, exemplary embodiment, which will be described hereinafter, the protective film 28 corresponds to a portion of the support layer 14. In addition, the covering layer 24 is limited in the horizontal orientation, i.e. along the x-y-plane, by the adhesive layer 19.

FIG. 2 represents a top view of the safety label 11 according to the invention as shown in FIG. 1. Owing to the protective film 28, which is transparent at least in specific zones, the covering layer 24 is visible. Since the covering layer 24 is saturated with coloured pigments, the underlying function layer 18 is not visible and is represented merely in a dot-dash line. Once an influence caused by a magnetic field is exerted on the safety label 11 and a certain force of the magnetic field has been reached, the magnetic particles begin to migrate, passing through the gel-like function layer 18, the photopolymerised layer 21 of the function layer and through the photopolymerised layer 26, if present, so as to migrate into the covering layer 24 and be incorporated in the covering layer 24 where their transmigration is stopped by the protective layer adjoining the covering layer 24. A change in colour of the covering layer 24 caused by this signalises the presence of the influence of a magnetic field with a given minimum force as such and, as the colour change increases, also signalises the duration of action of the magnetic field. By way of example, four indicators 29 may be provided, as shown in FIG. 2, said indicators comprising the function layer 18, the photopolymerised layer 21, the photopolymerised layer 26, if present, and the covering layer 24, with each of the indicators 29 varying in the viscosity of the function layer 18 and the covering layer 24 as well as in the layer thickness of the photopolymerised layer 21 and the further photopolymerised layer 26, if present. Thus it is possible to create a safety label 11 having for example a four-stage indication which, depending on the duration of action, gradually indicates said action in the respective covering layer 24. For example, the indicator 29′ will only indicate a beginning change in colour once the indicator 29 has completely changed colour. The same applies, by analogy, to the indicators 29″ and 29′″.

Alternatively, provision may be made for the indicators 29 and 29′ to be realised in a redundant manner, such that the safety label 11 offers a possibility to verify its own indication in the covering layer 24.

FIGS. 3a to c represent individual process steps for fabricating a safety label 11 according to the present invention. Upon a support layer 14, which is preferably transparent, at least in specific zones, a function layer 18, formed in a point-like or drop-like manner, is applied. Before, while, or after this is done, the covering layer 24 may be applied, which application is preferably carried out in a mirror-symmetric manner along a straight line 31 corresponding to a folding edge which is yet to be described. Subsequent to this, the adhesive layer 19 may be applied. Alternatively, provision may be made for the adhesive layer 19 to be applied at first, or subsequent to the application of the function layer 18 and prior to the application of the covering layer 24. The application of these layers 18, 19, and 24 is carried out using a screen printing technique. In a subsequent processing step, photopolymerised layers 21 and 26 are formed on the function layer 18 and on the covering layer 24, respectively, by means of a UV irradiation source, as can be seen in FIG. 3.

In the subsequent processing step, the support layer 14 is folded up along the straight line 31 which represents a folding edge, such that the covering layer 24 covers the function layer 18 in its entirety. This is represented in FIG. 3c. Subsequent thereto, the edge zones are trimmed, if necessary, and an adhesive layer 16 provided with a protective film 17 for protection purposes is applied to a top surface or a bottom surface of the safety label 11.

All of the characteristics described hereinabove are relevant with regard to the invention, as considered either in themselves or in any combination with each other.

1. A safety label allowing magnetic influences exerted thereon to be visualised by means of magnetically responsive metal particles arranged in a multi-layer construction, with the multi-layer construction comprising at least one support layer, wherein a gel-like function layer containing magnetically responsive metal particles incorporated therein is applied to the support layer, at least in specific zones, and surrounded by an adhesive layer arranged on the support layer, that the gel-like function layer is covered by a gel-like covering layer provided on a protective layer, such that the magnetically responsive metal particles may migrate from the function layer to the covering layer when exposed to a magnetic influence and the proportion of metal particles having passed into the covering layer is visualable.

2. The safety label as claimed in claim 1, wherein the gel-like function layer is solvent-free.

3. The safety label as claimed in claim 1, wherein the gel-like function layer is saturated with magnetically responsive metal particles.

4. The safety label as claimed in claim 1, wherein the covering layer is realised in the form of a solvent-free layer.

5. The safety label as claimed in claim 1, wherein the covering layer, as considered in a planiform extension, is larger than the gel-like function layer that is to be covered.

6. The safety label as claimed in claim 1, wherein on the gel-like function layer a photopolymerised layer is formed using irradiation.

7. The safety label as claimed in claim 1, wherein on a covering layer a photopolymerised layer is formed using irradiation.

8. The safety label as claimed in claim 1, wherein the transmigration speed of the magnetic metal particles into the covering layer is determined as a function of the viscosity of the function layer.

9. The safety label as claimed in claim 1, wherein the transmigration speed of the magnetic metal particles into the covering layer is determined as a function of the thickness of the polymerised layer present on the function layer.

10. The safety label as claimed in claim 1, wherein the immigration of the magnetic metal particles into the covering layer is determined as a function of the viscosity of the covering layer.

11. The safety label as claimed in claim 1, wherein the immigration of the magnetic metal particles into the covering layer is determined as a function of the thickness of the photopolymerised layer of the covering layer.

12. The safety label as claimed in claim 1, wherein the covering layer is provided with coloured pigments which are different from the metal particles and the protective film is realised as a transparent film, at least in the zone of the covering layer.

13. A method for fabricating a safety label allowing magnetic influences exerted thereon to be visualised
in which a gel-like function layer having magnetically responsive metal particles incorporated therein is applied to a support layer and extends along the plane of the support layer, at least over specific zones,
in which a covering layer is applied to a support layer in a mirror-symmetric manner with respect to the at least one function layer and extends along the plane of the support layer, at least over specific zones, said covering layer being formed in a planiform extension with a size equal to, or larger than, the function layer,
in which an adhesive layer is applied to the zones of the support layer which are not covered by the function layer and the covering layer, and
in which the support layer is bent and folded up along a straight line of the mirror-inverted arrangement formed between the at least one function layer and the at least one covering layer, such that the covering layer covers the function layer.

14. The method as claimed in claim 13, wherein, in particular prior to the folding-up of the support layer, the gel-like function layer is photopolymerised using an irradiation source.

15. The method as claimed in claim 13, wherein the covering layer is photopolymerised using an irradiation source.

16. The method as claimed in claim 13, wherein at least one of the function layer, the covering layer and the adhesive layer is applied using a screen printing technique or an ink-jet printing technique.

17. The method as claimed in claim 13, wherein the gel-like function layer is saturated to a proportional extent of at least 40% with magnetically responsive metal particles.

18. The method as claimed in claim 13, wherein the covering layer is saturated to an extent of at least 40% with coloured particles which are of a different colour than the magnetically responsive metal particles.

19. The method as claimed in claim 14, wherein a UV irradiation source is used.

20. The method as claimed in claim 15, wherein a UV irradiation source is used.
